(19) United States
(12) Patent Application Publication
(10) Pub. No.: US 2026/0064947 A1
(43) Pub. Date: Mar. 5, 2026

(54) UNSUPERVISED AUTO-LABELING OF DIALOGUE UTTERANCES FOR INTENT

(71) Applicant: Verint Americas Inc., Alpharetta, GA (US)

(72) Inventor: Grant ANDERSON, Erskine (GB)

(21) Appl. No.: 18/817,005

(22) Filed: Aug. 27, 2024

(51) Int. Cl. G06F 40/169; G06F 16/35; G06F 40/30

(52) U.S. Cl. CPC G06F 40/169; G06F 16/35; G06F 40/30

(57) ABSTRACT

A method for unsupervised auto-labeling of dialogue utterances with human-readable intent labels, the method including: receiving a series of text utterances; determining, using a pre-trained open intent discovery configuration prediction model, an open intent discovery configuration for the received series of text utterances based on a series of features of the series of text utterances; and using the determined open intent discovery configuration for performing the steps of: obtaining semantic representations of the series of received text utterances; generating clusters of intents based on the obtained semantic representations of the series of received text utterances; extracting candidate intent labels for the generated clusters; and labeling the generated clusters with a human-readable intent label selected from the extracted candidate intent labels.

### TECHNICAL FIELD

Aspects of the present disclosure relate to techniques for unsupervised auto-labeling of dialogue utterances with human-readable intent labels.

### BACKGROUND

Companies increasingly employ dialogue systems through the use of chatbots, virtual agents, and other conversation interfaces to assist with a variety of customer interactions. For example, dialogue systems are relied upon for end uses related to customer service, technical support, e-commerce, healthcare, education, entertainment, and more. Effective intent discovery helps to define the purpose and scope of a given dialogue system's interactions. Intent discovery for user utterances may also improve a dialogue system's ability to accurately understand and engage in meaningful conversation with a given user. As intent discovery improves, developers can more effectively tailor a given dialogue system's natural language processing capabilities, design more appropriate dialogue flows, and implement more relevant conversation flows, which all improves the user experience. As such, there is a need in the art to improve intent discovery capabilities, including improving their ability to discover intents when starting from a completely unlabeled dataset.

### SUMMARY

One aspect provides a method for unsupervised auto-labeling of dialogue utterances with human-readable intent labels. The method includes receiving a series of text utterances; determining, using a pre-trained open intent discovery configuration prediction model, an open intent discovery configuration for the received series of text utterances based on a series of features of the series of text utterances; and using the determined open intent discovery configuration for performing the steps of: obtaining semantic representations of the series of received text utterances; generating clusters of intents based on the obtained semantic representations of the series of received text utterances; extracting candidate intent labels for the generated clusters; and labeling the generated clusters with a human-readable intent label selected from the extracted candidate intent labels.

Another aspect provides for an apparatus configured for unsupervised auto-labeling of dialogue utterances with human-readable intent labels, comprising: one or more memories comprising processor-executable instructions; and one or more processors configured to execute the processor-executable instructions and cause the apparatus to: receive a series of text utterances; determine, using a pre-trained open intent discovery configuration prediction model, an open intent discovery configuration for the received series of text utterances based on a series of features of the series of text utterances; and using the determined open intent discovery configuration to: obtain semantic representations of the series of received text utterances; generate clusters of intents based on the obtained semantic representations of the series of received text utterances; extract candidate intent labels for the generated clusters; and label the generated clusters with a human-readable intent label selected from the extracted candidate intent labels.

Another aspect provides, a method for training an open intent discovery configuration prediction model, the method including sourcing a series of intent-labeled datasets; selecting a series of applicable intent discovery techniques; evaluating combinations of the selected series of applicable intent discovery techniques; determining an optimal open intent discovery configuration for each intent-labeled dataset from the sourced series of intent labeled datasets; and training the open intent discovery configuration prediction model using dataset features of the sourced series of intent-labeled datasets as input, and the determined open intent discovery configurations as outputs.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an exemplary open intent discovery framework and architectural components that may be used for performing methods of unsupervised auto-labeling of dialogue utterances with human-readable intent labels according to at least one embodiment.

FIG. 2 depicts an exemplary open intent discovery framework for performing methods of unsupervised auto-labeling of dialogue utterances with human-readable intent labels in which an open intent discovery configuration prediction system is employed according to at least one embodiment.

FIG. 3 depicts an exemplary operational flowchart for a process of training an open intent discovery configuration prediction model usable for methods of unsupervised auto-labeling of dialogue utterances with human-readable intent labels according to at least one embodiment.

FIG. 4 depicts an exemplary operational flowchart for an illustrative process of unsupervised auto-labeling of dialogue utterances with human-readable intent labels according to at least one embodiment.

FIG. 5 depicts a pair of tables including dataset features for a series of dialogue utterances that may be considered when performing described methods of unsupervised auto-labeling of dialogue utterances with human-readable intent labels according to at least one embodiment.

FIG. 6 depicts a bar graph comparing exemplary BART scores obtain using semi-supervised clustering methods (leveraging DeepAligned) with exemplary BART scores obtained using open intent discovery configurations including unsupervised methods for a series of unlabeled dialogue utterances according to at least one embodiment.

FIG. 7 depicts an exemplary processing system in which a system for unsupervised auto-labeling of dialogue utterances with human-readable intent labels according to at least one embodiment may be implemented.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure are directed to methods, processing systems, and computer-readable mediums for auto-labeling of dialogue utterances with human-readable intent labels. As previously discussed, companies increasingly employ dialogue systems through the use of chatbots, virtual agents, and other conversation interfaces to assist with a variety of customer interactions. Dialogue systems are relied upon for end uses related to customer service, technical support, e-commerce, healthcare, education, entertainment, and more. Effective intent discovery helps to define the purpose and scope of a given dialogue system's interactions. Intent discovery for user utterances may also improve a dialogue system's ability to accurately understand and engage in meaningful conversation with a given user. As intent discovery improves, developers can more effectively tailor a given dialogue systems natural language processing capabilities, design more appropriate dialogue flows, and implement more relevant conversation flows, which improves the user experience. As such, organizations continuously strive to improve intent discovery capabilities, including improving their ability to discover intents when starting from a completely unlabeled dataset.

However, there are many technical challenges to performing effective intent discovery within a given dialogue system. Discovering intents in dialogue systems can be a laborious and time-consuming task involving a domain expert exploring the dataset and curating a representative set of labels. Additionally, discovery tasks may be repeated regularly as new intents emerge over time. The field of Open Intent Discovery seeks to automatically discover unknown intents in a set of unlabeled or partially labeled utterances without requiring such manual effort. Proposed solutions typically involve development of clustering algorithms to identify utterances of similar intent, without progressing to label the cluster with a human-readable intent label. Thus, for downstream systems to make full use of the new intents, a human would be required to analyze the cluster manually, decide on its meaning and label it accordingly. Furthermore, there are many options for technique that may be employed at each stage of a given open intent discovery process. The optimal combination is dependent on the features of the utterances within a given dataset. It is difficult to employ an optimal configuration for open intent discovery without extensive domain knowledge or performing an expensive optimization procedure, such that an optimal technique may be selected for performing each respective step of the open intent discovery process.

Accordingly, methods, processing systems, and computer-readable mediums for auto-labeling of dialogue utterances with human-readable intent labels are provided, which overcome the aforementioned technical problems. In particular, aspects provide for open intent discovery systems capable of performing methods that include receiving a series of text utterances and determining an open intent discovery configuration for the received series of text utterances by leveraging a pre-trained open intent discovery configuration prediction model. The determined open intent discovery configuration may then be used when performing open intent discovery. Described aspects further provide for improved methods of open intent discovery. After obtaining semantic representations of the series of received text utterances and generating clusters of intents based on the obtained semantic representations, described aspects then extract candidate intent labels for the generated clusters. Described aspects may then label the generated clusters with human-readable intent labels.

Aspects described herein for auto-labeling of dialogue utterances with human-readable intent labels provide for improved open intent discovery. For example, by providing for auto-labeling of dialogue utterances with human-readable intent labels, described aspects overcome the challenge of costly manual labeling of data by domain experts. Additionally, described aspects leverage a pre-trained open intent discovery configuration prediction model to overcome the challenge, as described above, of having to identify which of the many available techniques to employ at various stages of open intent discovery. More specifically, described aspects are able to leverage a pre-trained open intent discovery configuration prediction model to process data and features associated with received text utterances to determine an optimal configuration (a specific set of techniques to employ) for respective performable steps of open intent discovery. This technical improvement may eliminate and replace the difficult task of having to manually select specific techniques for performing respective steps of open intent discovery. Furthermore, described aspects do not end the open intent discovery process at using clustering algorithms to identify utterances of similar intent. Instead, described aspects provide technical improvements that further extract candidate intent labels for generated clusters, allowing for selection of high quality human-readable intent labels from the extracted candidate labels without the need for manual intervention. By leveraging prompting and natural language processing techniques, described aspects generate improved high-quality human-readable intent labels that are more user-friendly and meaningful for facilitating downstream tasks.

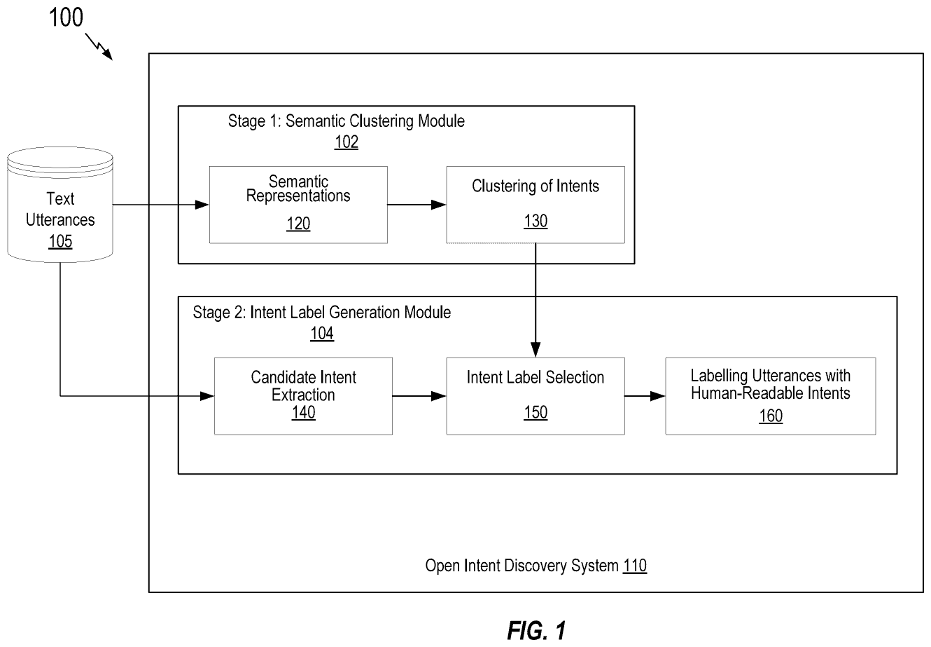

Turning to FIG. 1, an exemplary open intent discovery framework 100 and architectural components usable by an exemplary open intent discovery system 110 for performing methods of unsupervised auto-labeling of dialogue utterances with human-readable intent labels according to at least one aspect are depicted. Exemplary system architecture may be implemented as a system on one or more computing devices within a local network (e.g., a local area network (LAN)) or a distributed system on a plurality of computing devices on multiple networks in data communication with one another (e.g., a wide area network (WAN), Internet, or the like).

Open intent discovery framework 100 and accompanying architectural components of open intent discovery system 110 include in this example a semantic clustering module 102 for receiving and clustering a series of text utterances 105 and an intent label generation module 104 for generating and selecting labels to be applied to the generated clusters of received utterances.

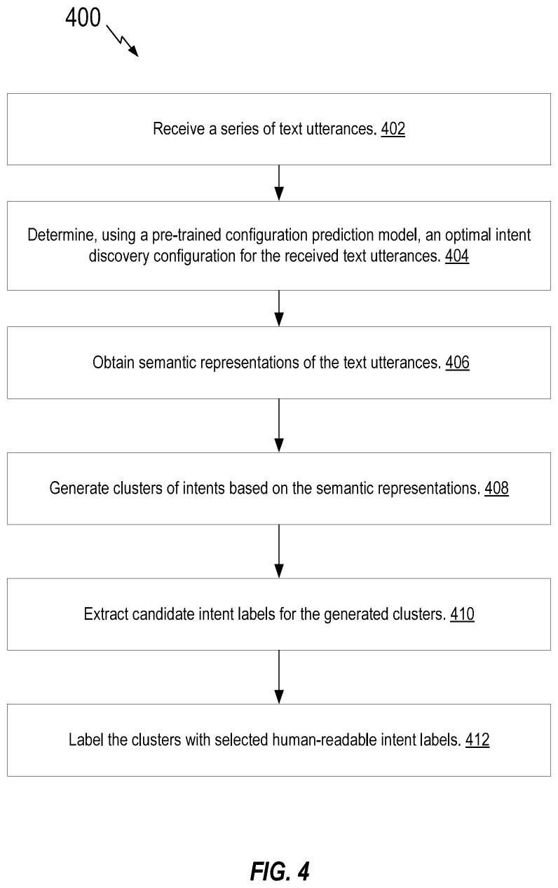

In aspects, the series of text utterances 105 may be processed by open intent discovery system 110 in a first stage using the semantic clustering module 102. First, semantic representations 120 of the received text utterances 105 are obtained. Open intent discovery system 110 may then perform clustering of intents 130 to cluster the semantic representations into clusters of intents. Open intent discovery system 110 may then perform steps of a second stage using the intent label generation module 104. In the second stage, open intent discovery system 110 may perform candidate intent extraction at 140, extracting intents from the received series of text utterances 105. Open intent discovery system 110 may then perform intent label selection at 150 by selecting intent labels for each of the clusters of intents. Thereafter, open intent discovery system may perform labeling of the received utterances with human-readable intents at 160 using the selected intent labels. Each of the above-described steps in the open intent discovery framework 100 will be described in greater detail below in connection with the illustrative operational flowchart for a process of unsupervised auto-labeling of dialogue utterances with human-readable intent labels according to at least one aspect depicted in FIG. 4. In some aspects, semantic clustering module 102 and intent label generation module 104 may be configured to leverage a pre-trained language model (not shown) for performing methods of unsupervised auto-labeling of dialogue utterances with human-readable intent labels discovery described herein.

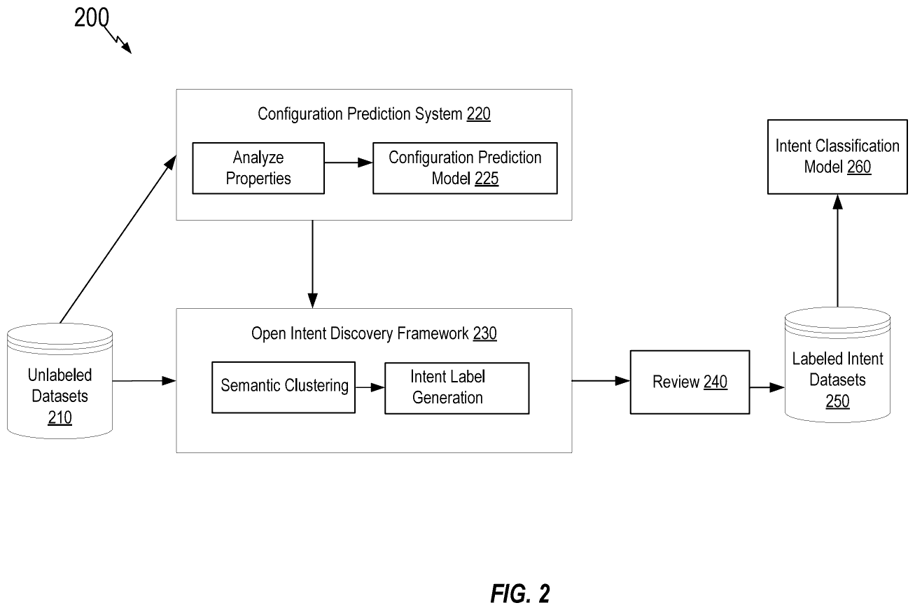

FIG. 2 depicts another exemplary framework 200 employable by open intent discovery system 110 for performing described methods of unsupervised auto-labeling of dialogue utterances with human-readable intent labels.

As shown, framework 200 further include an open intent discovery configuration prediction system 220 employable, for example, by open intent discovery system 110. An open intent discovery system 110 employing exemplary framework 200 may first input a series of unlabeled datasets 210 into an open intent discovery configuration prediction system 220. In aspects, open intent discovery configuration prediction system 220 may be configured to analyze the properties of the input unlabeled datasets 210. The results of this analysis, may then be input into an open intent discovery configuration prediction model 225. In aspects, open intent discovery configuration prediction model 225 may be a pre-trained model configured to determine an open intent discovery configuration for performing open intent discovery on the unlabeled datasets 210 based on the features of the unlabeled datasets. Open intent discovery configuration prediction model 225 may be a pre-trained model of any suitable type. For example, in some aspects, configuration prediction may be a supervised learning model using decision trees, or a fine-tuned large language model. After open intent discovery configuration prediction model 225 determines an open intent discovery configuration, open intent discovery system 110 then performs open intent discovery using an open intent discovery framework 230. Open intent discovery framework 230 includes semantic clustering and intent label generation in accordance with previously described open intent discovery framework 100 of FIG. 1. Next, open intent discovery system 110 receives user feedback via review 240. Then, labeled intent datasets 250, now labeled with human-readable intent labels, may be input into an intent classification model 260 for training the model for use in virtual agents.

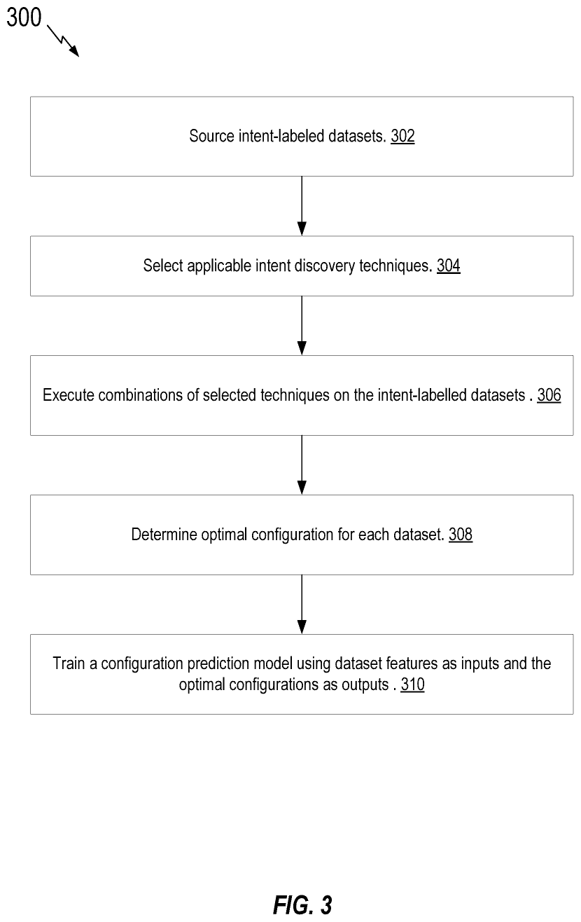

FIG. 3 depicts an exemplary operational flowchart for a process 300 of training an open intent discovery configuration prediction model usable for performing methods of unsupervised auto-labeling of dialogue utterances with human-readable intent labels according to at least one aspect. As discussed above, open intent discovery system 110 may include an open intent discovery configuration prediction system including a pre-trained open intent discovery configuration prediction model (such as open intent discovery configuration prediction system 220 including open intent discovery configuration prediction model 225 in FIG. 2). As used herein, an “open intent discovery configuration” refers to a combination of techniques that are selected for performing respective steps of open intent discovery. For example, an open intent discovery configuration may include a combination of techniques that are selected for performing the respective steps of open intent discovery framework 100 shown in FIG. 1, such as obtaining semantic representations at 120, clustering intents at 130, candidate intent extraction at 140, intent label selection at 150, and labeling of utterances with human-readable intents at 160. By training, and subsequently leveraging, an open intent discovery configuration prediction model, described aspects allow for improved methods of open intent discovery that may automatically select an optimal open intent discovery configuration based on features of the received datasets including the received text utterances. As used herein, “optimal open intent discovery configurations” refer to combinations of techniques usable for performing steps of open intent discovery (such as open intent discovery framework 230 of FIG. 2) that are predicted by pre-trained open intent discovery configuration prediction models (such as open intent discovery configuration prediction model 225 of FIG. 2) as usable to generate a series of most accurate (when compared to other possible configurations) human-readable intent labels for received unlabeled text utterances.

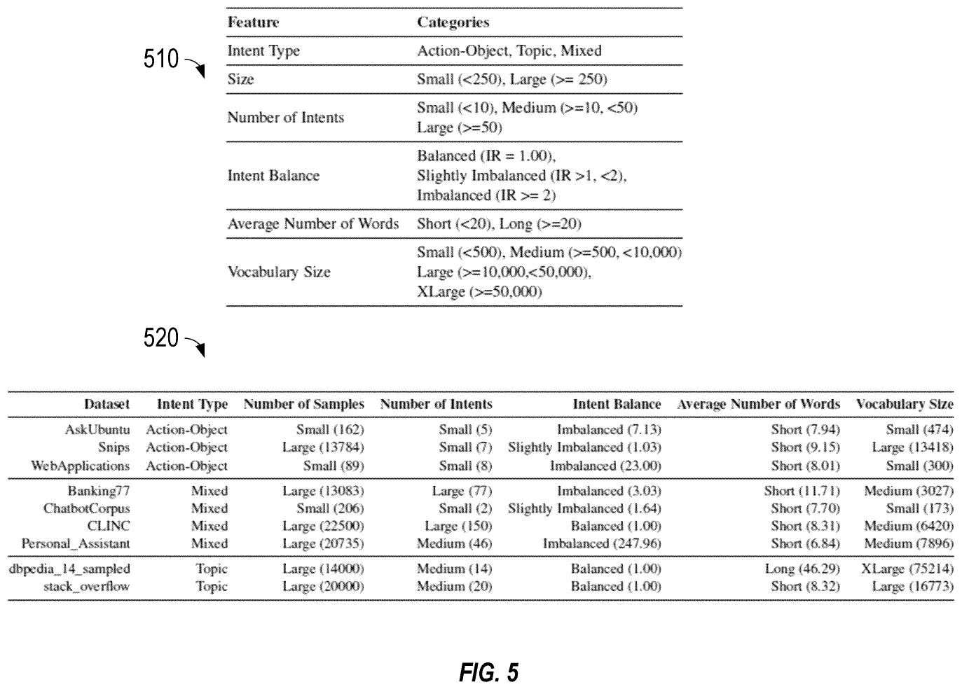

Process 300 begins at block 302 with sourcing intent-labeled datasets. The sourced intent-labeled datasets may be obtained from public or private sources. FIG. 5 depicts a pair of tables 510 and 520 including dataset features for a series of dialogue utterances that may be considered when performing described methods of unsupervised auto-labeling of dialogue utterances with human-readable intent labels according to at least one aspect. As shown in FIG. 5, table 510 includes exemplary dataset features associated with a series of received dialogue or text utterances including intent types, dataset size (number of samples within the dataset), number of ground-truth intent labels, balance of the intents, average number of words, and vocabulary size. In some aspects, other dataset features associated with a series of received dialogue or text utterances may be useful for determining an optimal open intent discovery configuration.

Certain datasets features of received text utterances may be impactful for determining an optimal open intent discovery configuration for performing open intent discovery. For example, regarding intent type, intents may be categorized as having actionable intent types (e.g., “can you reschedule my delivery” has the pair “reschedule-delivery”), while other datasets have more abstract labels that are closer to specific topics (topic intent types). In cases with abstract “topic intent types”, techniques using action-object extraction are unlikely to produce intents that reflect ground-truths because abstract intent types are less likely to involve tangible actions or objects and may include more nuanced meanings and subtleties that call for more context-dependent interpretation. Accordingly, a different extraction technique would likely produce better results. As shown in FIG. 5, table 510 considers three intent types including action-object, topic, or mixed (including both action-object and topic intent types).

In table 510, the “size” of the dataset refers to the number of samples in a given dataset, where small datasets have less than 250 samples, and large have over 250 samples. The “Number of Intents” refers to the number of ground-truth intent labels in a given dataset, which may be considered the number of clusters that should be found by a given clustering algorithm. “Small” refers to datasets having less than 10 ground-truth intent labels, “medium” refers to datasets having between 10-50 ground-truth intent labels, and “large” refers to datasets have over 50 ground-truth intent labels. “Intent balance” refers to ground-truth label distribution, where an imbalance ratio (IR) is used as a measure of imbalance by dividing the number of majority label samples by the number of minority label samples. An IR of 1.0 represents a completely balanced dataset with equal samples from every ground-truth label. IR in table 510 is categorized as “balanced”, “slightly imbalanced” when the IR is between 1.0 and 2.0, and “imbalanced” when the IR is above 2.0. In table 510, the “average number of words” refers to the average number of words within the received dialogue utterances. The “average number of words” can be categorized as “short” or “long” where “short” is less than 20 average words, and “long” is 20 or more average words. “Vocabulary size” refers to the number of unique words across all utterances in a received dataset. The “vocabulary size” in table 510 is categorized as “small” for less than 500 words, “medium” for 500 to 10,000 words, “large” for 10,000 to 50,000 words, and “xlarge” for over 50,000 words. The dataset features considered and the categorical definitions employed in Table 510 and 520 are merely illustrative, and may be modified as desired by a developer of an open intent discovery system 110 training an open intent discovery configuration prediction model in accordance with this disclosure.

Returning to FIG. 3, process 300 continues at block 304 with selecting applicable intent-discovery techniques. At block 304, all applicable intent-discovery techniques for performing each step of open intent discovery framework 100, as shown in FIG. 1, may be selected. As previously discussed, there are many options for performing each step of open intent discovery framework 100. Accordingly, training the open intent discovery configuration prediction model may include selecting and considering as many techniques as possible to ensure an accurate open intent discovery configuration predictions may be made downstream. For example, block 304 may include selecting techniques such as all-mpnet, bidirection encoder representations (BERT), Universal Sentence Encoding, Bidirectional and Auto-Regressive Transformers (BART), Robustly optimized BERT approach (RoBERTa), A Lite Bert (ALBERT), and Sentence-Bert (SBERT) for obtaining semantic representations (See semantic representations 120 in FIG. 1). Block 304 may further include selecting exemplary techniques, such as Kmeans clustering, density-based spatial clustering (DBSCAN), ITER_DBSCAN, and DeepAligned clustering, for clustering semantically similar intents during stage 1. Regarding stage 2, block 304 may further include selecting exemplary techniques such as Action-Object Pairs, and pre-trained language model prompting for candidate intent extraction, or techniques such as Most Frequent and pre-trained language model Prompting for intent label selection. In some aspects, block 304 may further include selecting techniques for cluster scoring, such as balanced, silhouette, and Davies Bouldin. In some aspects, block 304 may further include selecting techniques for any state of the art open intent discovery techniques as they may arise. The above-described selected techniques are merely illustrative, and many other techniques may be selected and included for consideration when training an exemplary pre-trained open intent discovery configuration prediction model in accordance with described aspects.

Process 300 then proceeds to block 306 with executing possible combinations of techniques (configurations) on each of the sourced datasets. In aspects, each open intent discovery configuration uses at least a clustering algorithm and a clustering measure for conducting hyperparameter tuning. In aspects, clustering may be attempted for a range of hyperparameter values and evaluated using a specified measure. Then, the hyperparameters with the best score according to the chosen clustering measure are used for the open intent discovery configuration. For example, if considering Kmeans techniques, estimating the optimal number of clusters k, this step may further include conducting clustering for k between 2 and 200, or the number of utterances in the dataset, whichever is lower.

Process 300 then proceeds to block 308 with determining optimal configuration for each dataset. In aspects, various automated metrics may be used to evaluate the quality of the final generated labels compared to the ground truth intents for the originally sourced datasets. In some aspects, one or more of average cosine similarity and average BARTscore may be the metrics used for evaluation. In one exemplary aspect, evaluating the possible open intent discovery configurations may include normalizing both the generated and ground truth labels by converting to lower case, splitting on Pascal/snake case to break down strings that follow naming conventions into individual components, and removing hyphens and embeddings obtained using Universal Sentence Encoder.

In an exemplary aspect, similarity scores for evaluating open intent discovery configurations may be calculated by considering each unique ground-truth (gt) label, defining C* as the subset of clusters where the most common ground-truth (mcgt) is equal to gt. The similarity score in this example, for each gt, is then the average of the similarity between the generated label and the megt for each cluster C* (sim(c)). In this example, if none of the identified clusters is assigned gt then the score is 0. This may be expressed in the following formula:

$$avg\_label \_sim ( gt ) = \{ \begin{matrix}\frac{{\sum }_{c ∈ C *} sim ( c )}{{N}_{C *}} , & if {N}_{C *} > 0 \\ 0 , & if {N}_{C *} = 0\end{matrix} \qquad ( 1 )$$

where N_{C}* is the number of clusters in C*. In some aspects, the final average similarity score for a given open intent discovery configuration may then be calculated using an equation expressed as follows:

$$config\_score = \frac{{\sum }_{gt ∈ GT} avg\_label \_sim ( gt )}{{N}_{GT}}$$

where GT is the set of all ground-truth intents and N_{GT} is the number of all ground truth intents. In such aspects, an optimal open intent discovery configuration for each dataset may be determined by which open intent discovery configuration produces the highest “config score”. The above-described example for calculating and optimal open intent discovery configuration is merely exemplary.

Process 300 then proceeds to block 310 with training an open intent discovery configuration prediction model by using the dataset features as input and the optimal open intent discovery configuration as output. In aspects, the open intent discovery configuration prediction model could be implemented with decision trees, fine-tuned LLMs, or other types of machine learning models.

Accordingly, process 300 produces a trained open intent discovery configuration prediction model configured to determine an open intent discovery configuration for performing methods of open intent discovery. Once trained, the open intent discovery configuration prediction model can output a best-guess open intent discovery configuration for labeling a series of received unlabeled text utterances based on a series of extracted features.

FIG. 4 depicts an exemplary operational flowchart for an illustrative process 400 of unsupervised auto-labeling of dialogue utterances with human-readable intent labels according to at least one aspect.

Illustrative process 400 may be performed by an open intent discovery system 110, and may include steps performed using a pre-trained open intent discovery configuration prediction system (such as previously described open intent discovery configuration prediction system 220 of FIG. 2) for employing optimal open intent discovery configurations for open intent discovery of received text utterances. In the context of this disclosure, while open intent discovery system 110 is sometimes described as performing open intent discovery on received “text utterances”, it is understood that open intent discovery system 110 may receive a variety of dialogue datasets for labeling, including conversation data, dialogue data, or utterance data of any form, such as text data, audio data (voice), symbols, or other suitable forms of dialogue or conversational communication that may be converted to the received series of text utterances.

Process 400 begins at block 402 with receiving a series of text utterances. In aspects, the received series of text utterances are either wholly, or partially unlabeled.

Process 400 then proceeds at block 404 with determining, using a pre-trained open intent discovery configuration prediction model, an open intent discovery configuration for the received series of text utterances based on a series of features of the series of text utterances. In aspects, open intent discovery system 110 may leverage an exemplary open intent discovery configuration prediction system (such as open intent discovery configuration prediction system 220 of FIG. 2) to extract a series of relevant features of the received series of text utterances from block 402. Then, based on the extracted series of relevant features associated with the received text utterances, a pre-trained open intent discovery configuration prediction model (such as open intent discovery configuration prediction model 225 of FIG. 2) may determine an open intent discovery configuration for performing the steps of the above-described described open intent discovery framework, such as the open intent discovery framework 100 depicted in FIG. 1. In some aspects, to determine the open intent discovery configuration, open intent discovery system 110 may traverse a decision tree having branches including conditional nodes corresponding to certain conditions related to previously described features of received text utterances, and leaf nodes corresponding to possible configurations that may be employed for performing open intent discovery. Open intent discovery system 110 may navigate the decision tree, and the conditional nodes therein, based on extracted features of the received text utterances until a leaf node is reached. Open intent discovery system 110 then determines the open intent discovery configuration for the received series of text utterances to be the configuration corresponding to the leaf node. Open intent discovery system 110 may now, using the determined open intent discovery configuration, proceed with process 400 by performing the previously described steps of the open intent discovery framework 100.

Process 400 then proceeds at block 406 with obtaining semantic representations of the series of received text utterances. In aspects, a semantic clustering module (such as semantic clustering module 102 as shown in FIG. 1) of open intent discovery system 110 may include and leverage pre-trained language models (PLMs) to obtain embeddings for the received text utterances. In aspects, the semantic clustering module of open intent discovery system 110 may implement, for example, any huggingface sentence-transformers or tensorflow-hub-based PLM embedding models. In an exemplary aspect, open intent discovery system 110 may rely upon bert-base-uncased, all-mpnet-base-v2, and Universal Sentence Encoder as the PLMs for obtaining embeddings for the received text utterances.

Process 400 then proceeds at block 408 with generating clusters of intents based on the obtained semantic representations of the series of received text utterances. In aspects, the generated cluster of intents may be obtained using any one of a variety of clustering algorithms depending upon the determined open intent discovery configuration being employed. For example, Kmeans algorithms may be used for clustering when finding clusters of similar sizes in a more balanced dataset of text utterances. In other aspects, density-based methods such as DBSCAN may be relied upon to handle uneven cluster sizes (for imbalanced datasets) and non-flat geometry. In some aspects, depending on the clustering algorithms used, finding optimal hyperparameter may involve a search across a hyperparameter space, and evaluating each cluster result against some metric.

Process 400 then proceeds at 410 with extracting candidate intent labels for the generated clusters, which corresponds to proceeding with stage 2 (such as candidate intent extraction 140 of FIG. 1) of open intent discovery framework 100. At block 410, open intent discovery system 110 may extract candidate labels from the generated clusters using, for example, a dependency parser, or by prompting a PLM. In aspects, an exemplary dependency parser may be a part of intent label generation module 104 of FIG. 1. In some aspects, open intent discovery system 110 may be configured to extract candidate intent labels by finding action-object pairs within the received text utterances. As used herein, action-object pairs may include a verb or infinitive (the “Action”) and its target, a noun or subject (the “Object”), forming a pair. For example, an action-object pair may include “schedule a meeting for tomorrow” containing the action-object pair “schedule-meeting”. Leveraging action-object pairs typically assumes a strict definition of intents, which could fail to produce certain abstract intents such as “query” or “confirmation”. Accordingly, in other aspects, open intent discovery system 110 may instead extract candidate intent labels by prompting a PLM to produce the candidate intent labels. For example, open intent discovery system 110 may prompt a PLM with a prompt stating “Given the following utterance: [utterance], what was the intent?” to obtain candidate intent labels.

In some aspects, open intent discovery system 110 may be configured to instead extract candidate intent labels using an extension of the described action-object extraction methods. For example, rather than each of the “Objects” having been tagged by a dependency parser as a noun, certain aspects may remove this restriction to allow for additional tags such as proper nouns, using “compound” rules to cause a leveraged parser to find compound nouns, and “amod rules” to cause a leveraged parser to find descriptive words that modify the “Object”. In some aspects, an extension of the action-object extraction method may further involve utilizing “neg” rules configured to cause a leveraged parser to look for negations attached to the “Action”, allowing for more descriptive candidates that take the form:
(NEG_)ACTION-(ADJECTIVES_)(COMPOUNDS_)OBJECT
   where the terms in parentheses are only present if they exist in the utterance.

Process 400 then proceeds at block 412 with labeling the generated clusters with a human-readable intent label selected from the extracted candidate intent labels. In some aspects, open intent discovery system 110 may label the generated clusters with a human-readable intent label by selecting a most frequent extracted candidate intent label from the series of extracted candidate intent labels. In other aspects, open intent discovery system 110 may instead be configured to prompt a PLM to determine a best fitting intent from a series of extracted candidate intent labels. For example, open intent discovery system may prompt a PLM with a prompt stating “Given these utterances: [cluster_utterances]. What is the best fitting intent, if any, among the following: [top_3_candidates]?” Using this prompt, the PLM prompted by open intent discovery system 110 may determine, from the top three candidate prompts, which intent label fits a given cluster best. In some instances, due to caveats in the prompt, such as “if any” as used above, the prompt may cause the PLM to suggest an entirely different candidate label not contained in the top three most frequent extracted candidates, providing improved flexibility. In aspects, open intent discovery system 110 may prompt a PLM to both select a human-readable intent label from the extracted candidate intent labels, and to apply the selected human-readable intent label to the generated cluster being considered, thereby labeling the generated cluster.

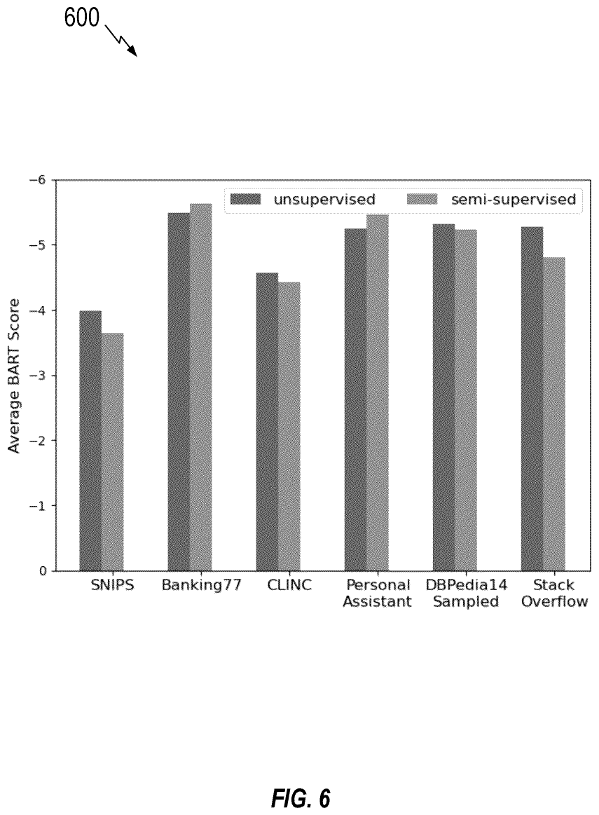

FIG. 6 depicts a bar graph 600 comparing exemplary BART scores obtain using semi-supervised clustering methods (e.g., leveraging DeepAligned) with exemplary BART scores obtained using open intent discovery configurations including unsupervised methods for a series of unlabeled dialogue utterances according to at least one aspect. As shown in bar graph 600, the quality of the unsupervised generated human-readable intent labels (in accordance with described processes 400 with reference to FIG. 4) outperform the semi-supervised clustering methods for the “Banking77” and “Personal Assistant” datasets.

Open intent discovery system 110 thus provides for improved methods of open intent discovery. Presently described aspects provide for open intent discovery systems capable of performing methods that include receiving a series of text utterances and determining an open intent discovery configuration for the received series of text utterances by leveraging a pre-trained open intent discovery configuration prediction model. The determined open intent discovery configuration may then be used when performing open intent discovery. This eliminates the difficult task of having to manually select specific techniques for performing respective steps of open intent discovery without any understanding of which specific techniques may be optimal for labeling text utterances with human-readable intent labels based on the features of the received text utterances. After obtaining semantic representations of the series of received text utterances and generating clusters of intents based on the obtained semantic representations, described aspects then extract candidate intent labels for the generated clusters. Described aspects may then label the generated clusters with human-readable intent labels. By leveraging prompting and natural language processing techniques, described aspects provide more user-friendly, high quality intent labels that are easier to read and comprehend. Furthermore, the generated human-readable intent labels are generated automatically, overcoming the challenge of relying upon costly domain experts to manually label data.

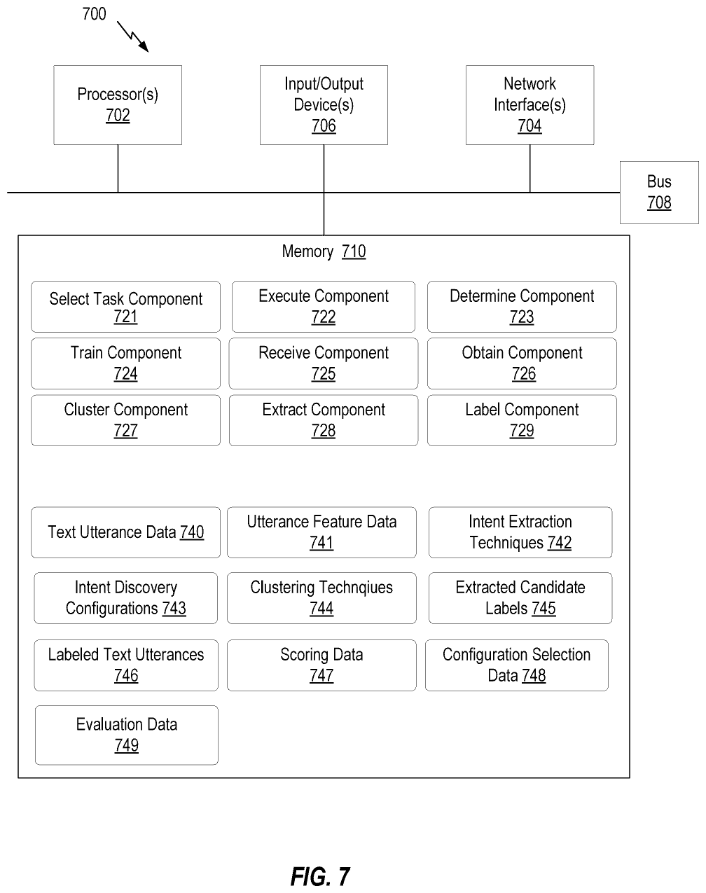

FIG. 7 depicts an example processing system 700 in which an exemplary open intent discovery system (such as open intent discovery system 110 of FIG. 1), as described above, may be implemented.

Processing system 700 includes one or more processors 702. Generally, processor(s) 702 may be configured to execute computer-executable instructions (e.g., software code) to perform various methods and functions, as described herein.

Processing system 700 further includes one or more network interface(s) 704, which generally provides data access to any sort of data network, including personal area networks (PANs), local area networks (LANs), wide area networks (WANs), the Internet, and the like.

Processing system 700 further includes input(s) and output(s) 706, which generally provide means for providing data to and from Processing system 700, such as via connection to computing device peripherals, including user interface peripherals.

Processing system 700 further includes a memory 710 configured to store various types of components and data.

Processing system 700 further includes a bus 708, which may generally be configured for data and/or power exchange amongst the components. Bus 708 may be representative of multiple buses, while only one is depicted for simplicity.

In this example, memory 710 includes a select task component 721, an evaluate component 722, a determine component 723, a train component 724, a receive component 725, an obtain component 726, a cluster component 727, an extract component 728, and a label component 279.

The select task component 721 is configured to perform at least block 304 of the process 300 of training an open intent discovery configuration prediction model depicted and described with reference to FIG. 3.

The execute component 722 is configured to perform at least block 306 of the process 300 of training an open intent discovery configuration prediction model depicted and described with reference to FIG. 3.

The determine component 723 is configured to perform at least block 308 of the process 300 of training an open intent discovery configuration prediction model depicted and described with reference to FIG. 3 and block 404 of the process 400 of unsupervised auto-labeling of dialogue utterances with human-readable intent labels depicted and described with reference to FIG. 4.

The train component 724 is configured to perform at least block 310 of the process 300 of training an open intent discovery configuration prediction model depicted and described with reference to FIG. 3.

The receive component 725 is configured to perform at least block 402 of the process 400 of unsupervised auto-labeling of dialogue utterances with human-readable intent labels depicted and described with reference to FIG. 4.

The obtain component 726 is configured to perform at least block 406 of the process 400 of unsupervised auto-labeling of dialogue utterances with human-readable intent labels depicted and described with reference to FIG. 4.

The cluster component 727 is configured to perform at least block 408 of the process 400 of unsupervised auto-labeling of dialogue utterances with human-readable intent labels depicted and described with reference to FIG. 4.

The extract component 728 is configured to perform at least block 410 of the process 400 of unsupervised auto-labeling of dialogue utterances with human-readable intent labels depicted and described with reference to FIG. 4.

The label component 729 is configured to perform at least block 412 of the process 400 of unsupervised auto-labeling of dialogue utterances with human-readable intent labels depicted and described with reference to FIG. 4.

In this example, memory 710 also includes at least the following: text utterance data 740, utterance feature data 741, intent extraction techniques 742, intent discovery configurations 743, clustering techniques 744, extracted candidate labels 745, labeled text utterance 746, scoring data 747, configuration selection data 748, and evaluation data 749.

Memory 710 may include additional components or data that are not shown as may be useful for employing the systems and methods described herein.

Processing system 700 may be implemented in various ways. For example, processing system 700 may be implemented within on-site, remote, or cloud-based processing equipment.

Processing system 700 is just one example, and other configurations are possible. For example, in alternative embodiments, aspects described with respect to processing system 700 may be omitted, added, or substituted for alternative aspects.

### EXAMPLE CLAUSES

Clause 1: A method for unsupervised auto-labeling of dialogue utterances with human-readable intent labels, the method including: receiving a series of text utterances; determining, using a pre-trained open intent discovery configuration prediction model, an open intent discovery configuration for the received series of text utterances based on a series of features of the series of text utterances; and using the determined open intent discovery configuration for performing the steps of: obtaining semantic representations of the series of received text utterances; generating clusters of intents based on the obtained semantic representations of the series of received text utterances; extracting candidate intent labels for the generated clusters; and labeling the generated clusters with a human-readable intent label selected from the extracted candidate intent labels.
Clause 2: The method of Clause 1, wherein obtaining the semantic representations of the series of received text utterances further includes generating embedding using at least one pre-trained language model.
Clause 3: The method of Clause 2, wherein extracting the candidate intent labels for the generated clusters further includes extracting action-object pairs in the received series of text utterances.
Clause 4: The method of any of Clauses 1-3, wherein extracting the candidate intent labels for the generated clusters further includes prompting a pre-trained language model to produce the extracted candidate intent labels.
Clause 5: The method of any of Clauses 1-4, wherein the features of the series of text utterances comprise at least intent types, number of samples, number of intents, intent balance, average number of words, and vocabulary size.
Clause 6: The method of any of Clauses 1-5, wherein labeling the generated clusters with a human-readable intent label selected from the extracted candidate intent labels further includes: prompting a pre-trained language model to select the human-readable intent label from the extracted candidate intent labels; and applying the selected human-readable intent label to the generated clusters.
Clause 7: The method of any of Clauses 1-6, wherein the pre-trained open intent discovery configuration prediction model comprises one of a supervised learning model or a fine-tuned large language model.
Clause 8: An apparatus configured for unsupervised auto-labeling of dialogue utterances with human-readable intent labels, comprising: one or more memories comprising processor-executable instructions; and one or more processors configured to execute the processor-executable instructions and cause the apparatus to: receive a series of text utterances; determine, using a pre-trained open intent discovery configuration prediction model, an open intent discovery configuration for the received series of text utterances based on a series of features of the series of text utterances; and using the determined open intent discovery configuration to: obtain semantic representations of the series of received text utterances; generate clusters of intents based on the obtained semantic representations of the series of received text utterances; extract candidate intent labels for the generated clusters; and label the generated clusters with a human-readable intent label selected from the extracted candidate intent labels.
Clause 9: The apparatus of Clause 8, wherein to obtain the semantic representations of the series of received text utterances, the apparatus is further configured to: generate embedding using at least one pre-trained language model.
Clause 10: The apparatus of Clause 9, wherein to extract the candidate intent labels for the generated clusters, the apparatus is further configured to extract action-object pairs in the received series of text utterances.
Clause 11: The apparatus of any of Clause 8-10, wherein to extract the candidate intent labels for the generated clusters, the apparatus is further configured to: prompt a pre-trained language model to produce the extracted candidate intent labels.
Clause 12: The apparatus of any of Clause 8-11, wherein the features of the series of text utterances comprise at least intent types, number of samples, number of intents, intent balance, average number of words, and vocabulary size.
Clause 13: The apparatus of any of Clause 8-12, wherein to label the generated clusters with a human-readable intent label selected from the extracted candidate intent labels, the apparatus is further configured to: prompt a pre-trained language model to select the human-readable intent label from the extracted candidate intent labels; and apply the selected human-readable intent label to the generated clusters.
Clause 14: The apparatus of any of Clause 8-13, wherein the pre-trained open intent discovery configuration prediction model comprises one of a supervised learning model or a fine-tuned large language model.
Clause 15: A method for training an open intent discovery configuration prediction model, the method comprising: sourcing a series of intent-labeled datasets; selecting a series of applicable intent discovery techniques; executing combinations of the selected series of applicable intent discovery techniques; determining an optimal open intent discovery configuration for each intent-labeled dataset from the sourced series of intent labeled datasets; and training the open intent discovery configuration prediction model using dataset features of the sourced series of intent-labeled datasets as input, and the determined open intent discovery configurations as outputs.
Clause 16: The method of Clause 15, wherein the selected series of applicable intent discovery techniques are usable for at least: obtaining semantic representations of received text utterances; clustering intents of the received text utterances; extracting candidate intent labels for the received text utterances; and selecting labels, from the extracted candidate intent labels, for the received text utterances.
Clause 17: The method of Clause 16, wherein evaluating the combinations of the selected series of applicable intent discovery techniques further comprises: determining one or more of average cosine similarity and average Bidirectional and Auto-Regressive Transformers (BART) scores for a series of intent labels generated using each of the combinations of the selected series of applicable intent discovery techniques.
Clause 18: The method of any of Clauses 15-17, wherein the open intent discovery configuration prediction model comprises one of a supervised learning model or a fine-tuned large language model.
Clause 19: The method of any of Clauses 15-18, wherein the received text utterances include comprising at least intent types, number of samples, number of intents, intent balance, average number of words, and vocabulary size.
Clause 20: The method of any of Clauses 15-19, wherein the received text utterances are derived from a series of dialogue datasets comprising at least one of conversation data, dialogue data, or utterance data, the series of dialogue datasets comprising one or more of text data or audio data.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for unsupervised auto-labeling of dialogue utterances with human-readable intent labels, the method comprising:
receiving a series of text utterances;
determining, using a pre-trained open intent discovery configuration prediction model, an open intent discovery configuration for the received series of text utterances based on a series of features of the series of text utterances; and
using the determined open intent discovery configuration for performing a series of steps including:
obtaining semantic representations of the series of received text utterances;
generating clusters of intents based on the obtained semantic representations of the series of received text utterances;
extracting candidate intent labels for the generated clusters; and
labeling the generated clusters with a human-readable intent label selected from the extracted candidate intent labels.

2. The method of claim 1, wherein obtaining the semantic representations of the series of received text utterances further comprises: generating embedding using at least one pre-trained language model.

3. The method of claim 1, wherein extracting the candidate intent labels for the generated clusters further comprises: extracting action-object pairs in the received series of text utterances.

4. The method of claim 1, wherein extracting the candidate intent labels for the generated clusters further comprises: prompting a pre-trained language model to produce the extracted candidate intent labels.

5. The method of claim 1, wherein the features of the series of text utterances comprise at least intent types, number of samples, number of intents, intent balance, average number of words, and vocabulary size.

6. The method of claim 1, wherein labeling the generated clusters with a human-readable intent label selected from the extracted candidate intent labels further comprises:
prompting a pre-trained language model to select the human-readable intent label from the extracted candidate intent labels; and
applying the selected human-readable intent label to the generated clusters.

7. The method of claim 1, wherein the pre-trained open intent discovery configuration prediction model comprises one of a supervised learning model or a fine-tuned large language model.

8. An apparatus configured for unsupervised auto-labeling of dialogue utterances with human-readable intent labels, comprising: one or more memories comprising processor-executable instructions; and one or more processors configured to execute the processor-executable instructions and cause the apparatus to:
receive a series of text utterances;
determine, using a pre-trained open intent discovery configuration prediction model, an open intent discovery configuration for the received series of text utterances based on a series of features of the series of text utterances; and
use the determined open intent discovery configuration to:
obtain semantic representations of the series of received text utterances;
generate clusters of intents based on the obtained semantic representations of the series of received text utterances;
extract candidate intent labels for the generated clusters; and
label the generated clusters with a human-readable intent label selected from the extracted candidate intent labels.

9. The apparatus of claim 8, wherein to obtain the semantic representations of the series of received text utterances, the apparatus is further configured to: generate embedding using at least one pre-trained language model.

10. The apparatus of claim 8, wherein to extract the candidate intent labels for the generated clusters, the apparatus is further configured to extract action-object pairs in the received series of text utterances.

11. The apparatus of claim 8, wherein to extract the candidate intent labels for the generated clusters, the apparatus is further configured to: prompt a pre-trained language model to produce the extracted candidate intent labels.

12. The apparatus of claim 8, wherein the features of the series of text utterances comprise one or more of intent types, number of samples, number of intents, intent balance, average number of words, and vocabulary size.

13. The apparatus of claim 8, wherein to label the generated clusters with a human-readable intent label selected from the extracted candidate intent labels, the apparatus is further configured to:
prompt a pre-trained language model to select the human-readable intent label from the extracted candidate intent labels; and
apply the selected human-readable intent label to the generated clusters.

14. The apparatus of claim 8, wherein the pre-trained open intent discovery configuration prediction model comprises one of a supervised learning model or a fine-tuned large language model.

15. A method for training an open intent discovery configuration prediction model, the method comprising:
sourcing a series of intent-labeled datasets;
selecting a series of applicable intent discovery techniques;
executing combinations of the selected series of applicable intent discovery techniques;
determining an optimal open intent discovery configuration for each intent-labeled dataset from the sourced series of intent labeled datasets; and
training the open intent discovery configuration prediction model using dataset features of the sourced series of intent-labeled datasets as input, and the determined open intent discovery configurations as outputs.

16. The method of claim 15 wherein the selected series of applicable intent discovery techniques are usable for at least:
obtaining semantic representations of received text utterances;
clustering intents of the received text utterances;
extracting candidate intent labels for the received text utterances; and
selecting labels, from the extracted candidate intent labels, for the received text utterances.

17. The method of claim 15 wherein evaluating the combinations of the selected series of applicable intent discovery techniques further comprises:
determining one or more of average cosine similarity and average Bidirectional and Auto-Regressive Transformers (BART) scores for a series of intent labels generated using each of the combinations of the selected series of applicable intent discovery techniques.

18. The method of claim 15, wherein the open intent discovery configuration prediction model comprises one of a supervised learning model or a fine-tuned large language model.

19. The method of claim 16, wherein the received text utterances include comprising at least intent types, number of samples, number of intents, intent balance, average number of words, and vocabulary size.

20. The method of claim 16, wherein the received text utterances are derived from a series of dialogue datasets comprising at least one of conversation data, dialogue data, or utterance data, the series of dialogue datasets further comprising one or more of text data or audio data.
